(19) United States
(12) Patent Application Publication
(10) Pub. No.: US 2018/0083770 A1
(43) Pub. Date: Mar. 22, 2018

(54) DETECTING ENCODING ATTACK

(71) Applicant: Hangzhou DPtech Technologies Co., Ltd., Zhejiang Province (CN)

(72) Inventors: Shixing ZHAI, Zhejiang Province (CN); Ning ZHANG, Zhejiang Province (CN); Wenwen ZHANG, Zhejiang Province (CN)

(73) Assignee: Hangzhou DPtech Technologies Co., Ltd., Zhejiang Province (CN)

(21) Appl. No.: 15/710,049

(22) Filed: Sep. 20, 2017

(30) Foreign Application Priority Data
Sep. 21, 2016 (CN) 201610837577.7

(51) Int. Cl. H04L 9/00; G06F 21/56; H04L 29/06

(52) U.S. Cl. CPC H04L 9/002; G06F 21/57; H04L 63/1416; G06F 21/563

(57) ABSTRACT

A method of detecting an encoding attack, an Intrusion Prevention System (IPS) device, and a storage medium are provided. The method includes: determining whether an un-decoded character exists in a structure corresponding to a session to which a received packet belongs, wherein the structure is configured to store the un-decoded character, an encoding manner and a multi-pattern matching progress corresponding to the session; combining the un-decoded character and a payload of the received packet to obtain a combined character sequence when the un-decoded character exists in the structure; decoding the combined character sequence according to the encoding manner to obtain a decoded character sequence; performing a multi-pattern matching on the decoded character sequence based on a pre-configured attack feature, the multi-pattern matching progress and a preset multi-pattern matching algorithm; and determining whether there is an attack according to a result of the multi-pattern matching.

### CROSS REFERENCE TO RELATED APPLICATIONS

This application claims priority to Chinese Patent Application No. 201610837577.7, which is filed on Sep. 21, 2016, the entire content of which is incorporated herein by reference.

### TECHNICAL FIELD

The present disclosure relates to detecting an encoding attack in the field of information security.

### BACKGROUND

With the number of network intrusion events increasing and the level of attack continuously advancing, networks of some enterprises and units may be attacked. For this reason, an Intrusion Prevention System (IPS) device may be deployed for protecting their networks from being attacked. The IPS device may detect an attack based on a feature matching principle. For example, the IPS device may compare a packet in a network with a pre-issued attack feature. If the packet includes the attack feature (hereinafter, also be referred to as “the packet matches the attack feature”), it may be determined that there is an attack in the packet. Otherwise, if the packet does not include the attack feature (also be referred to as “does not match the attack feature”), the packet may be released.

### SUMMARY

In view of the above, the present disclosure provides a method of detecting an encoding attack, an IPS device and a storage medium.

According to a first aspect of one or more examples of the present disclosure, the method of detecting an encoding attack is provided. The method includes:

determining, by an Intrusion Prevention System (IPS) device, whether an un-decoded character exists in a structure corresponding to a session to which a received packet belongs, wherein the structure is configured to store the un-decoded character, an encoding manner and a multi-pattern matching progress corresponding to the session;

combining, by the IPS device, the un-decoded character and a payload of the received packet to obtain a combined character sequence when the un-decoded character exists in the structure;

decoding, by the IPS device, the combined character sequence according to the encoding manner in the structure to obtain a decoded character sequence;

performing, by the IPS device, a multi-pattern matching on the decoded character sequence based on a pre-configured attack feature, the multi-pattern matching progress and a preset multi-pattern matching algorithm; and

determining, by the IPS device, whether there is an attack according to a result of the multi-pattern matching.

According to a second aspect of one or more examples of the present disclosure, an IPS device is provided. The device including: a processor and a a machine-readable storage medium storing machine executable instructions which are executed by the processor to:

determine whether an un-decoded character exists in a structure corresponding to a session to which a received packet belongs, wherein the structure is configured to store the un-decoded character, an encoding manner and a multi-pattern matching progress corresponding to the session;

combine the un-decoded character and a payload of the received packet to obtain a combined character sequence when the un-decoded character exists in the structure;

decode the combined character sequence according to the encoding manner in the structure to obtain a decoded character sequence;

perform a multi-pattern matching on the decoded character sequence based on a pre-configured attack feature, the multi-pattern matching progress and a preset multi-pattern matching algorithm; and

determine whether there is an attack according to a result of the multi-pattern matching.

According to a third aspect of one or more examples of the present disclosure, a machine-readable storage medium storing machine executable instructions is provided, which are invoked and executed by a processor to perform the method of detecting the encoding attack described by the first aspect of the present disclosure.

Since a structure for storing the un-decoded character and the multi-pattern matching progress is provided in the present disclosure, on the one hand, the IPS device will not discard temporarily any un-decodable character in the process of performing multi-pattern matching on the received packet; on the other hand, when the attack feature is across packets, the IPS device may continue to perform the multi-pattern matching based on the stored multi-pattern matching progress. In this way, when the attack feature is across packets, the probability of obtaining the entire attack feature may be increased.

The details of one or more examples of the subject matter described in the present disclosure are set forth in the accompanying drawings and description below. Other features, aspects, and advantages of the subject matter will become apparent from the description, the drawings, and the claims. Features of the present disclosure are illustrated by way of example and not limited in the following figures, in which like numerals indicate like elements.

### BRIEF DESCRIPTION OF DRAWINGS

FIG. 1 illustrates a flow chart of a method of detecting an encoding attack according to an example of the present disclosure.

FIG. 2 illustrates a flow chart of a method of detecting an encoding attack according to another example of the present disclosure.

FIG. 3 illustrates a schematic diagram of a feature binary tree according to an example of the present disclosure.

FIG. 4 illustrates a functional module diagram of an apparatus for detecting an encoding attack according to an example of the present disclosure.

FIG. 5 illustrates a hardware structure diagram of an IPS device according to an example of the present disclosure.

### DETAILED DESCRIPTION

The technical solution in examples of the present disclosure will be described in further detail with reference to the accompanying drawings, so that the technical solution in examples of the present disclosure is better understood by those skilled in the art and the above objective, the feature and the advantage of examples of the present disclosure are more apparent.

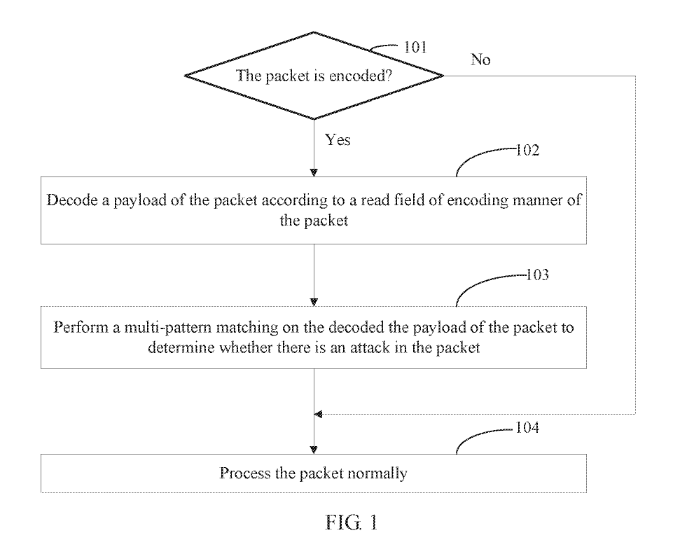

FIG. 1 illustrates a flow chart of a method of detecting an encoding attack according to an example of the present disclosure. The technical solution may be applied to an IPS device. The method of detecting the encoding attack may include block 101-104.

At block 101, the IPS device receives a packet and determines whether the packet is encoded or not. If the packet is not encoded, the block 104 may be performed; and if the packet is encoded, the block 104 may be performed.

At block 102, the IPS device decodes a payload of the packet according to a read field of encoding manner of the packet.

At block 103, the IPS device performs a multi-pattern matching on the decoded the payload of the packet to determine whether there is an attack in the packet or not.

At block 104, the IPS device processes the packet normally.

In an example, the IPS device may pre-configure two butlers (such as buffer A and buffer B) in a memory, where the buffer A may be configured to store the payload of the packet, and the buffer B may be configured to store a character sequence obtained by decoding the payload of the packet.

After receiving a packet, the IPS device may read a field of encoding manner of the packet and determine whether the packet is encoded according to information recorded in the field of encoding manner. If the field of encoding manner is null, it indicates that the packet is not encoded. At this time, the packet does not include an encoded attack feature, The IPS device may process the packet normally. If the field of encoding manner is not null, it indicates that the packet is encoded.

If confirming that the packet is encoded, the IPS device may copy the payload of the packet to the pre-configured buffer A, and then decode the payload of the packet according to the information recorded in the field of encoding manner of the packet, and output the decoded character sequence to the buffer B. Here, the decoded character sequence is the decoded payload of the packet.

When the decoding is completed and the decoded character sequence is output to the buffer B, the IPS device may perform a multi-pattern matching on the decoded character sequence in the buffer B according to a pre-issued attack feature and a preset multi-pattern matching algorithm. For example, the IPS device may compare the attack feature with the decoded character sequence. If the decoded character sequence includes the attack feature, it is determined that there is an attack in the packet, and therefore the packet is intercepted; and otherwise, the packet is processed normally.

However, in the case of encoding packet, an encoded packet generated from an original packet may have a larger length than that of the original packet. For example, when encoding packet according to an 8-bit Unicode Transformation Format (UTF-8, it is a variable-length character encoding for Unicode), 1 to 6 bytes may be used to encode each Unicode. If each Unicode is encoded into 6 bytes, the length of an encoded packet will be increased by 6 times after the packet is encoded.

In this case, the encoded packet may be segmented during network transmission with an increased likehood, and thus an attack feature carried by the packet may also be segmented. For example, the attack feature may be carried by a plurality of segmented packets.

However, the method shown in FIG. 1 may not be able to detect an encoding attack by an attack feature across packets. For the attack feature across packets, decoding a single (segmented) packet may obtain one or more un-decoded characters. The IPS device usually maintains a maximum fault tolerance when processing the segmented packets. For example, the IPS device may skip an un-decoded character directly when processing the un-decoded characters. In this case, if a part of the attack feature happens to be carried in the un-decoded characters which have been skipped, the entire attack feature cannot be obtained by the IPS device even if the IPS device obtains other parts of the attack feature, and thus the feature matching fails and the attack packet cannot be detected.

To solve the above problem, in the technical solution of examples of the present disclosure, for the attack feature across packets, the un-decoded character and a multi-pattern matching progress may be stored. When receiving a new packet, the IPS device may combine a payload of the new packet and the stored un-decoded character to obtain a combined character sequence, and then decode the combined character sequence to obtain a decoded character sequence. When the decoding is completed, the multi-pattern matching is performed on the decoded character sequence based on a pre-configured attack feature and the stored multi-pattern matching progress. Further, each time the multi-pattern matching is completed and when the entire attack feature is not obtained, the IPS device may update the multi-pattern matching progress. In this way, when the attack feature is across packets caused by segmentation of the encoded packet, the probability of obtaining the entire attack feature may be increased, and the problem that the IPS device cannot detect the attack packet may be effectively solved.

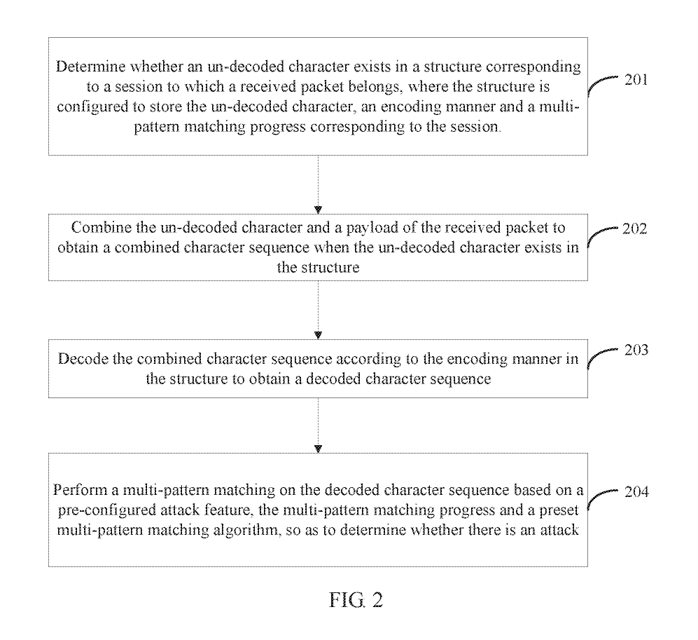

FIG. 2 illustrates a flow chart of a method of detecting an encoding attack by an attack feature across packets according to an example of the present disclosure. The executing subject of the method may be an IPS device; and the method includes the following blocks 201-204.

At block 201, it is determined whether an un-decoded character exists in a structure corresponding to a session to which a received packet belongs; where the structure is configured to store the un-decoded character, an encoding manner and a multi-pattern matching progress corresponding to the session.

At block 202, the un-decoded character and a payload of the received packet are combined to obtain a combined character sequence when the un-decoded character exists in the structure.

At block 203, the combined character sequence is decoded according to the encoding manner in the structure to obtain a decoded character sequence.

At block 204, based on a pre-configured attack feature, the multi-pattern matching progress and a preset multi-pattern matching algorithm, a multi-pattern matching is performed on the decoded character sequence, so as to determine whether there is an attack.

The above multi-pattern matching algorithm may be configured to search for a plurality of pattern character sequences in a paragraph of a text, and may be applied to the aspects such as keyword filtering, intrusion detection, virus detection, word segmentation, etc. In the present disclosure, the multi-pattern matching algorithm may be configured to detect the attack packet. Herein the multi-pattern matching algorithm may include a The tree, an Aho-Corasick (AC) algorithm, a Wu-Manber (WM) algorithm, etc.

Hereinafter, the technical solution of the present disclosure will be described with the AC algorithm as an example. Of course, in a practical application, the above multi-pattern matching algorithm may be other types of multi-pattern matching algorithms as well, which will not be described in detail herein.

Herein, the multi-pattern matching based on the AC algorithm may also be referred to as AC searching. Similarly, the multi-pattern matching progress may also be referred to as AC searching progress.

In this example, the AC searching may be completed based on the pre-configured attack feature which may be from a feature library. A large number of attack features from the feature library are compiled as a feature binary tree,

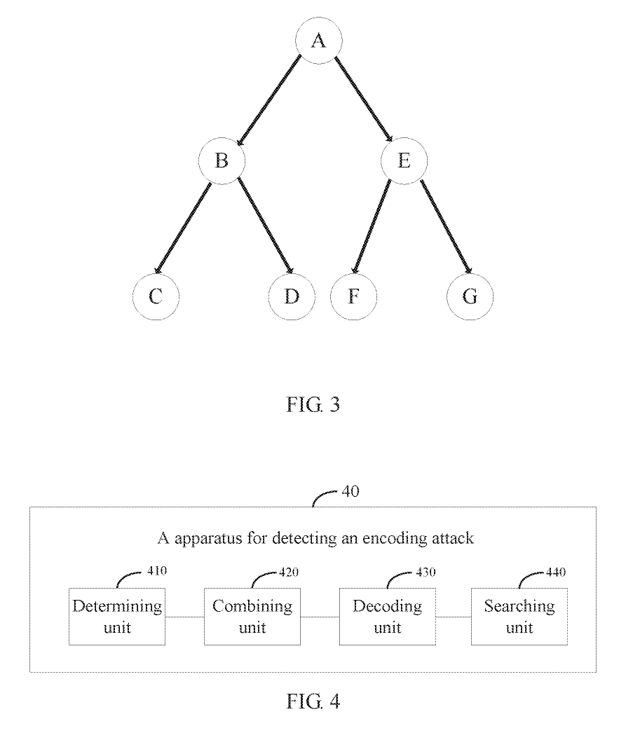

FIG. 3 illustrates a schematic diagram of a feature binary tree according to an example of the present disclosure. ABC, ABD, AEG, and AEF are attack features, respectively. Based on the attack features, the IPS device performs a matching on the decoded character sequence. If any attack feature can be matched in one packet, it is determined that the packet is an attack packet. If the attack feature is across packets, the attack feature is carried by a plurality of packets after being segmented. At this time, if the entire attack feature is not obtained, the AC searching progress needs to be recorded. For example, if AB is obtained by the AC searching in a first packet, the AB is the AC searching progress at this time and the AC searching progress may be recorded. The AC searching is continued based on the AC searching progress in a second packet to obtain ABC. Thus, it may be determined that there is an attack.

In the present disclosure, when the attack feature is across packets, by storing an un-decoded character and an AC searching progress during the AC searching, packets belonging to a same session are associated, such that the attack feature carried by a plurality of packet are collected and detected gradually. In this way, when the attack feature is across packets, the problem of detecting an attack packet may be solved effectively.

In this example, when receiving a packet, the IPS device may first read a field of encoding manner (for example, a char-set field) of the received packet, and then determine whether the received packet is encoded based on information recorded in the field of encoding manner.

Herein there are many manners for encoding packet, such as UTF-8 encoding. The UTF-8 encoding is a variable length character encoding for Unicode.

On the one hand, when the field of encoding manner of the packet is null, it indicates that the packet is not encoded. In this case, the packet does not carry an encoded attack feature. The packet may be processed normally.

On the other hand, when the packet is encoded, it may carry the encoded attack feature. Since the length of the packet will be increased after encoded, the possibility that the packet is segmented during network transmission is greatly increased. If a segmented packet carries a part of the attack feature, the attack feature may be across packets at this time, for example, the attack feature may be carried by a plurality of packets. Therefore, a relationship may be established for packets belonging to a same session to detect the attack feature carried by the plurality of packets.

In an example, the IPS device may establish a corresponding structure for different sessions, respectively. The structure is configured to store relevant information corresponding to the above session. For example, the structure may store an un-decoded character, an encoding manner, and an AC searching progress corresponding to the above session.

In this example, when the IPS device determines that the received packet (hereinafter, may be referred to as the interested packet) is encoded, it may first determine whether there is a structure corresponding to the session (hereinafter referred to as the interested session) to which the interested packet belongs.

On the one hand, if the structure corresponding to the interested session does not exist, it indicates that it is the first time to receive the packet for the interested session. In this case, a structure may be created for the interested session, and the read encoding manner of the packet may be stored in the structure, so as to decode other packets for the interested session according to the encoding manner subsequently.

On the other hand, if there is a structure corresponding to the interested session, it indicates that a packet for the interested session has been received previously. Thus, the above structure may include an un-decoded character left by decoding a particular packet in the interested session. The un-decoded character may include a part of the attack feature and therefore needs to be decoded.

Similar to the previous description, two buffers (such as buffer A and buffer B) may be pre-configured in a memory of the IPS device. The buffer A is configured to store an un-decoded character and a payload of a packet to be decoded. The buffer B is configured to store a decoded character sequence.

In this example, when the IPS device decodes the above received interested packet, it is determined whether there is an un-decoded character in the structure corresponding to the interested session.

On the one hand, if there is an un-decoded character in the above structure, it may include a part of the attack feature and may be associated with a feature included in the interested packet (in a case of the above interested packet also including a part of attack feature). At this time, the un-decoded character and the payload of the interested packet may be combined to obtain a combined character sequence, and the combined character sequence may be then copied to the buffer A.

After the combined character sequence is copied to the buffer A, the encoding manner in the above structure is obtained and then used to decode the combined character sequence to obtain a decoded character sequence. The decoded character sequence is then stored in the buffer B.

At this time, if an un-decodable character which is obtained from decoding the combined character sequence, the un-decodable character may be stored as a new un-decoded character in the above structure. The above un-decodable character may be associated with a feature included in other subsequent received packets for the interested session, so the above un-decodable character may be stored to avoid the omission of an attack feature.

After the decoding is completed, the AC searching progress in the above structure may be obtained. AC searching may be performed on the decoded character sequence in the buffer B based on the AC searching progress and the pre-configured attack feature. After the searching is completed, the AC searching progress may be updated according to the searching result to determine whether there is an attack.

Herein, if the entire attack feature exists in the updated AC searching progress, it indicates that there are attack packets. At this time, the attack packets may be intercepted.

In addition, if the attack feature in the updated AC searching progress is incomplete, the updated AC searching progress may be stored in the above structure. Since the attack feature may be carried by a plurality of packets after being encoded, the AC searching progress may be stored, so that each time a packet carrying a part of the attack feature is received, the AC searching progress may be updated, until the entire attack feature is obtained.

In addition, if the updated AC searching progress is the same as the AC searching progress prior to the update, it indicates that there is no attack feature in the decoded character sequence and therefore the interested packet is not an attack packet. In this case, the interested packet may be processed normally.

On the other hand, if there is no un-decoded character in the above structure, the payload of the interested packet may be copied to the buffer A, and then the encoding manner in the above structure may be obtained. The payload of the interested packet may be decoded to obtain a decoded character sequence according to the encoding manner. The decoded character sequence is stored in the buffer B. At this time, if there is an un-decodable character which is obtained from decoding the payload of the interested packet, the un-decodable character is stored as an un-decoded character in the above structure. The un-decodable character may be associated with a feature included in a subsequent received packet, so the un-decodable character may be stored to avoid the omission of the attack feature.

After the decoding is completed, the AC searching progress in the above structure is obtained. AC searching is performed on the decoded character sequence in the buffer B based on the AC searching progress and the pre-configured attack feature. After the searching is completed, the AC searching progress may be updated according to the searching result to determine whether there is an attack.

Here if the entire attack feature exists in the updated AC searching progress, it indicates that there are attack packets. At this time, the attack packets may be intercepted.

In addition, if the attack feature present in the updated AC searching progress is incomplete, the updated AC searching progress is stored in the above structure. Since the attack feature may be carried by a plurality of packets after being encoded, the AC searching progress may be stored, so that each time a packet carrying a part of the attack feature is received, the AC searching progress may be updated until the entire attack feature is obtained.

In addition, if the updated AC searching progress is the same as the AC searching progress prior to the update, it indicates that there is no attack feature in the decoded character sequence and therefore the interested packet is not an attack packet. In this case, the interested packet may be processed normally,

According to one or more examples of the present disclosure, by storing the un-decoded character and the multi-pattern matching progress, when receiving a new packet, a payload of the new packet and the un-decoded character may be combined to obtain a combined character sequence, the combined character sequence may be decoded to obtain a decoded character sequence and the decoded character sequence may be performed a multi-pattern matching based on the multi-pattern matching progress. In this way, the attack feature carried by a plurality of packets may be decoded and detected, therefore increasing the probability of obtaining the entire attack feature when the attack feature is across packets.

Corresponding to examples of the method of detecting an encoding attack in the present disclosure, the present disclosure further provides an IPS device for performing the above method.

FIG. 4 illustrates a functional module diagram of an apparatus for detecting an encoding attack according to an example of the present disclosure.

As shown in FIG. 4, the apparatus 40 for detecting an encoding attack may include a determining unit 410, a combining unit 420, a decoding unit 430, and a searching unit 440.

The determining unit 410 may be configured to determine whether an un-decoded character exists in a structure corresponding to a session to which a received packet belongs, wherein the structure is configured to store the un-decoded character, an encoding manner and a multi-pattern matching progress corresponding to the session.

The combining unit 420 may be configured to combine the un-decoded character and the payload of the received packet to obtain a combined character sequence when the un-decoded character exists in the structure.

The decoding unit 430 may be configured to decode the combined character sequence according to the encoding manner in the structure to obtain a decoded character sequence.

The searching unit 440 may be configured to perform a multi-pattern matching on the decoded character sequence, based on a pre-configured attack feature, the multi-pattern matching progress and a preset multi-pattern matching algorithm to determine whether the packet is an attack.

In this example, the device may further include a reading unit configured to read a field of encoding manner of the received packet.

In this case, the determining unit 410 may further be configured to determine whether the received packet is encoded based on information recorded in the field of encoding manner.

In an example, the determining unit 410 may be further configured to determine whether there is a structure corresponding to the session to which the received packet belongs; create a structure for the session to which the received packet belongs when the structure corresponding to the session does not exist; and store the encoding manner of the received packet in the structure.

In an example, the apparatus may further include a storing unit configured to update the multi-pattern matching progress recorded in the structure when the entire attack feature is not obtained after the multi-pattern matching is performed on the decoded character sequence.

In an example, the decoding unit 430 may be further configured to decode the payload of the received packet according to the encoding manner recorded in the structure when there is no un-decoded character in the structure.

The searching unit 440 may be further configured to perform a multi-pattern matching on the decoded payload of the packet based on the pre-configured attack feature, the multi-pattern matching progress and the preset multi-pattern matching algorithm.

The storing unit may be further configured to update the multi-pattern matching progress recorded in the structure when an entire attack feature is not obtained.

The storing unit may be further configured to store an un-decodable character which is obtained from decoding the combined character sequence as a new un-decoded character in the structure.

In this example, the multi-pattern matching algorithm is an AC algorithm.

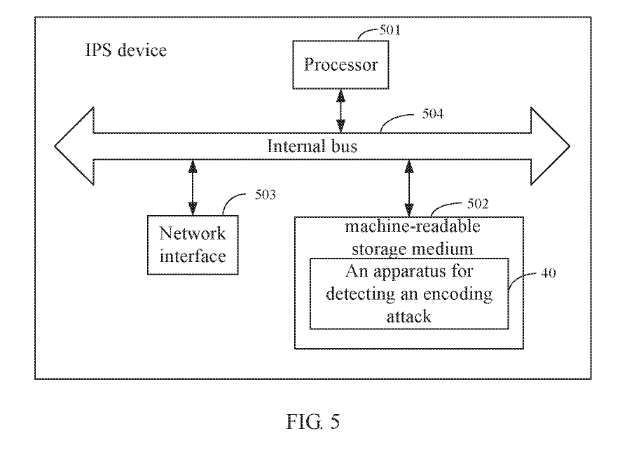

The apparatus for detecting an encoding attack in the present disclosure may be applied to an IPS device. The apparatus example may be implemented by software, or may be implemented by hardware or a combination of hardware and software. Take software as an example. As a logical apparatus, it is formed by reading computer program instructions in a non-volatile storage to a memory. From a hardware level, FIG. 5 illustrates a hardware structure diagram of an IPS device according to an example of the present disclosure. In addition to a processor 501, a machine-readable storage medium 502, a network interface 503, and an internal bus 504 shown in FIG. 5, the IPS device may further include other hardware according to the actual function of the apparatus for detecting an encoding attack, which will not be described herein.

The present disclosure further provides a machine-readable storage medium including machine executable instructions, such as the machine-readable storage medium 502 in FIG. 5. The machine executable instructions may be executed by the processor 501 in the IPS device to implement the method of detecting an encoding attack described above.

The implementation process of the functions and effects of the respective units in the above apparatus is described in detail in the implementation process of the corresponding blocks in the above method, which will not be described herein.

Since the apparatus embodiments substantially correspond to the method embodiments, reference may be made to part of the descriptions of the method embodiments for the related part. The apparatus embodiments described above are merely illustrative, where the units described as separate members may be or not be physically separated, and the members displayed as units may be or not be physical units, i.e., may be located in one place, or may be distributed to a plurality of network units. Part or all of the modules may be selected based on actual requirements to implement the objectives of the solutions in the present disclosure. Those of ordinary skill in the art may understand and carry out them without creative work.

The above description is merely preferred examples of the present disclosure and is not intended to limit the present disclosure, and any modifications, equivalent substitutions, adaptations, thereof made without departing from the spirit and scope of the present disclosure shall be encompassed in the claimed scope of the present disclosure.

1. A method of detecting an encoding attack, comprising:
determining, by an Intrusion Prevention System (IPS) device, whether an un-decoded character exists in a structure corresponding to a session to which a received packet belongs, wherein the structure is configured to store the un-decoded character, an encoding manner and a multi-pattern matching progress corresponding to the session;
combining, by the IPS device, the un-decoded character and a payload of the received packet to obtain a combined character sequence when the un-decoded character exists in the structure;
decoding, by the IPS device, the combined character sequence according to the encoding manner in the structure to obtain a decoded character sequence;
performing, by the IPS device, a multi-pattern matching on the decoded character sequence based on a pre-configured attack feature, the multi-pattern matching progress and a preset multi-pattern matching algorithm; and
determining, by the IPS device, whether there is an attack according to a result of the multi-pattern matching.

2. The method according to claim 1, further comprising:
reading, by the IPS device, a field of encoding manner of the received packet; and
determining, by the IPS device, whether the received packet is encoded based on information recorded in the field of encoding manner.

3. The method according to claim further comprising:
determining, by the IPS device, whether there is a structure corresponding to the session to which the received packet belongs;
creating, by the IPS device, a structure for the session to which the received packet belongs when the structure corresponding to the session does not exist; and
storing, by the IPS device, the encoding manner of the received packet in the structure.

4. The method according to claim 1, further comprising:
updating, by the IPS device, the multi-pattern matching progress recorded in the structure according to the result of the multi-pattern matching.

5. The method according to claim 1, further comprising:
decoding, by the IPS device, the payload of the received packet according to the encoding manner recorded in the structure when there is no un-decoded character in the structure.

6. The method according to claim 1, further comprising:
storing, by the IPS device, an un-decodable character which is obtained from decoding the combined character sequence as a new un-decoded character in the structure.

7. The method according to claim 1, wherein the multi-pattern matching algorithm is an Aho-Corasick (AC) algorithm.

8. The method according to claim 1, further comprising:
pre-configuring, by the IPS device, a first buffer and a second buffer in its memory; wherein
the first buffer is configured to store the rug-decoded character and the payload of the received packet; and
the second buffer is configured to store the decoded character sequence.

9. An Intrusion Prevention System (IPS) device, comprising:
a processor; and
a machine-readable storage medium storing machine executable instructions which are executed by the processor to:
determine whether an un-decoded character exists in a structure corresponding to a session to which a received packet belongs, wherein the structure is configured to store the un-decoded character, an encoding manner and a multi-pattern matching progress corresponding to the session;
combine the un-decoded character and a payload of the received packet to obtain a combined character sequence when the un-decoded character exists in the structure;
decode the combined character sequence according to the encoding manner in the structure to obtain a decoded character sequence;
perform a multi-pattern matching on the decoded character sequence based on a pre-configured attack feature, the multi-pattern matching progress and a preset multi-pattern matching algorithm; and
determine whether there is an attack according to a result of the multi-pattern matching.

10. The device according to claim 9, wherein the processor is further caused by the machine executable instructions to:
read a field of encoding manner of the received packet; and
determine whether the received packet is encoded based on information recorded in the field of encoding manner.

11. The device according to claim 9, wherein the processor is further caused by the machine executable instructions to:
determine whether there is a structure corresponding to the session to which the received packet belongs;
create a structure for the session to which the received packet belongs when the structure corresponding to the session does not exist; and
store the encoding manner of the received packet in the structure.

12. The device according to claim 9, wherein the processor is further caused by the machine executable instructions to:
update the multi-pattern matching progress recorded in the structure according to the result of the multi-pattern matching.

13. The device according to claim 9, wherein the processor is further caused by the machine executable instructions to:
decode the payload of the received packet according to the encoding manner recorded in the structure when there is no un-decoded character in the structure.

14. The device according to claim 9, wherein the processor is further caused by the machine executable instructions to:
store an un-decodable character which is obtained from decoding the combined character sequence as a new un-decoded character in the structure.

15. The device according to claim 9, wherein the multi-pattern matching algorithm is an Aho-Corasick (AC) algorithm.

16. The device according to claim 9, wherein the processor is further caused by the machine executable instructions to:
pre-configure a first buffer and a second buffer in a memory of the processor; wherein
the first buffer is configured to store the un-decoded character and the payload of the packet; and
the second buffer is configured to store the decoded character sequence.

17. A machine-readable storage medium storing machine executable instructions, which are invoked and executed by a processor to perform the method of detecting the encoding attack described by claim 1.
